(19) United States
(12) Patent Application Publication
(10) Pub. No.: US 2013/0239428 A1
(43) Pub. Date: Sep. 19, 2013

(54) METHOD TO REVERSE CYLINDER DRIVE IN A DIRECT BELT ON BASKET DRYER/TUMBLER

(71) Applicant: Stephen Harris, Oshkosh, WI (US)

(72) Inventor: Stephen Harris, Oshkosh, WI (US)

(73) Assignee: Alliance Laundry Systems LLC, Ripon, WI (US)

(21) Appl. No.: 13/420,119

(22) Filed: Mar. 14, 2012

(51) Int. Cl. F26B 11/02

(52) U.S. Cl. 34/108

(57) ABSTRACT

A laundry dryer having a front opening tumbler basket rotatably driven in opposite rotary directions during a drying operation by a drive motor mounted on a rear panel of the dryer cabinet. The drive motor drives a drive belt disposed about a drive pulley, a rear portion of the basket, and a plurality of idler pulleys. A support rod upon which the motor is supported and shafts of the idler pulleys each are affixed to and supported by a metal stabilizing member fixed to the rear cabinet panel and dimensioned so as to be stronger and more robust than the relatively thin walled rear cabinet panel for stabilizing the axes of the idler pulleys and drive motors for more reliable reversible operation.

### FIELD OF THE INVENTION

The present invention relates generally to laundry dryers, and more particularly, to laundry dryers in which the laundry containing tumbler basket is driven by a reversible motor in alternative rotary directions.

### BACKGROUND OF THE INVENTION

Laundry dryers commonly have a laundry containing tumbler basket driven by a drive belt which surrounds a rear portion of the basket. Since there is no pulley about the basket, only belt tension and idler and drive pulleys maintain proper direction of the belt. While it is desirable to drive the basket in opposite rotary directions to prevent tangling of large items, such as sheets, linens, and the like contained in the basket during drying, reversing the direction of drive can cause the belt to come off centered, resulting in edge wear and shortening of belt life, or complete dislodgement of the belt from the drive or idler pulleys. Moreover, sequential reversing of the rotary direction of the drive motor can create fatigue, cracking, or tearing of the sheet metal panel of the dryer cabinet upon which the drive motor is mounted by virtue of shock forces and vibrations occurring during reversible operation.

### OBJECTS AND SUMMARY OF THE INVENTION

It is an object of the present invention to provide a laundry dryer with a belt driven tumbler basket that is adapted for more reliable reversible operation.

Another object is to provide a laundry dryer as characterized above in which the drive belt is maintained in stable centered position on the drive and idler pulleys for more reliable operation.

A further object is to provide a laundry dryer of the above kind in which the drive motor has a mounting that resists fatigue cracking and tearing of the cabinet wall upon which the motor is mounted during reversible driving movement of the tumbler basket.

Still another object is to provide a laundry dryer of the foregoing type with a drive motor mounting arrangement that is relatively simple in design and lends itself to easy manufacture.

Other objects and advantages of the invention will become apparent upon reading the following detailed description and upon reference to the drawings, in which:

### BRIEF DESCRIPTION OF THE DRAWINGS

FIG. 1 is a perspective of an illustrative laundry dryer in accordance with the invention;

FIG. 2 is an enlarge perspective of the laundry dryer shown in FIG. 1 with portions of the cabinet removed in order to depict internal components of the dryer;

FIG. 3 is a diagrammatic depiction of the tumbler basket of the illustrated laundry dryer;

FIG. 4 is an exploded perspective of a tumbler basket drive motor and its mounting arrangement in the illustrated dryer;

FIG. 5 is an enlarged perspective of the drive motor supported within its mounting;

FIG. 6 is an enlarged fragmentary perspective showing a biasing mechanism for the drive motor mounting;

FIG. 7 is a further perspective of the illustrated drive motor mounting showing drive and idler pulleys in relation to the tumbler basket drive belt;

FIG. 8 is a perspective of a stabilizing member of the illustrated drive motor mounting arrangement; and

FIG. 9 is a side elevational view of the stabilizing member shown in FIG. 8.

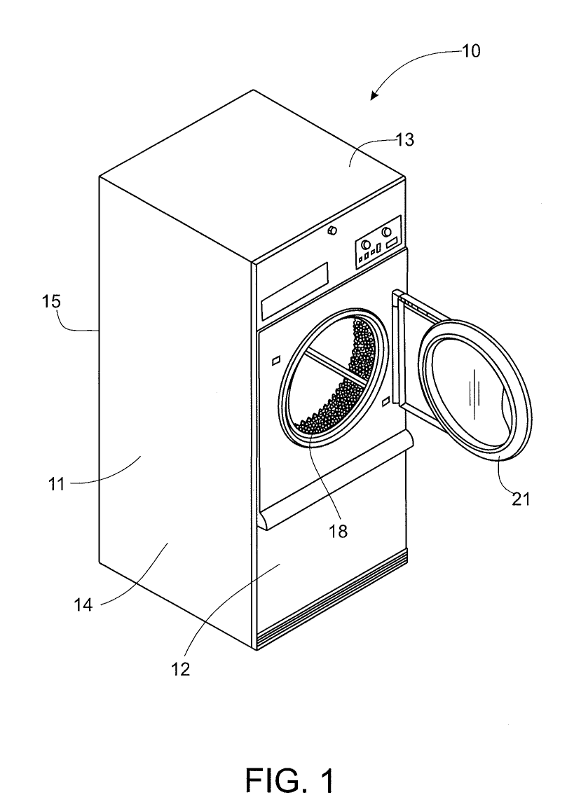

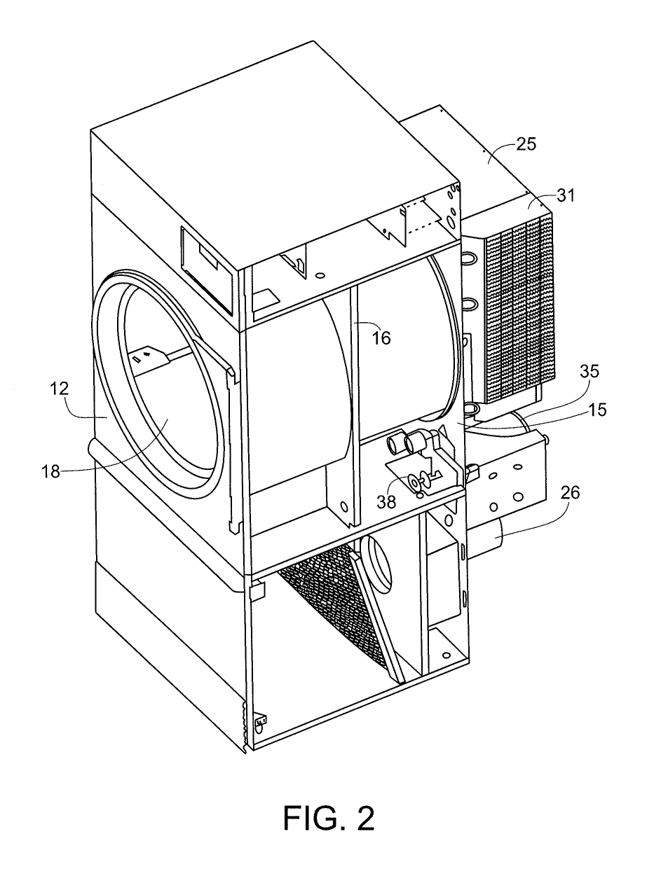

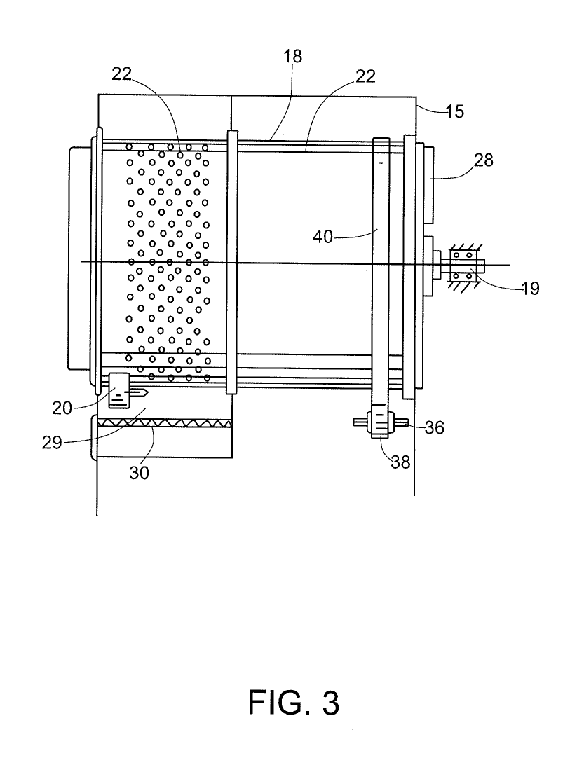

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

Referring now more particularly to the drawings, there is shown an illustrative laundry dryer 10 in accordance with the invention. The illustrated dryer 10 includes an outer cabinet 11 comprising a plurality of relatively thin sheet metal panels, including a front panel 12, top panel 13, side panels 14, a rear panel 15, and a center panel 16 between the front and rear panels 12,15. A front opening tumbler basket 18 is rotatably disposed within the cabinet 11 by a rearwardly extending axial 19 and a pair of rollers 20 supported within the cabinet 11 below a front end of the tumbler basket 18.

A conventional front opening door 21 is mounted in the front panel 12 for enabling access to the tumbler basket 18. The tumbler basket 18 in this case has a perforated rear axial end through which heated air is introduced into the tumbler basket 18 in a conventional manner, a rearward unperforated cylindrical portion 22 disposed in sealed relation between the rear panel 15 and the center partition 16, and a forward perforated cylindrical portion 24 disposed between the center partition 16 and the front panel 12.

For heating items within the tumbler basket 18 during a drying operation, a heater 25, which may be electric or gas powered, is mounted on a rear panel 15 of the dryer and a fan 26 is mounted below the heater 25. As is known in the art, hot air is drawn from the heater 25 through an air inlet 28 communicating with the perforated rear axial end of the tumbler basket 18, through the basket 18 and an air outlet 29 communicating with the forward perforated basket portion 22, through a lint filter 30, and then from the fan 20 to the outside environment. A protective guard 31 in this case is mounted on a side of the heater 25.

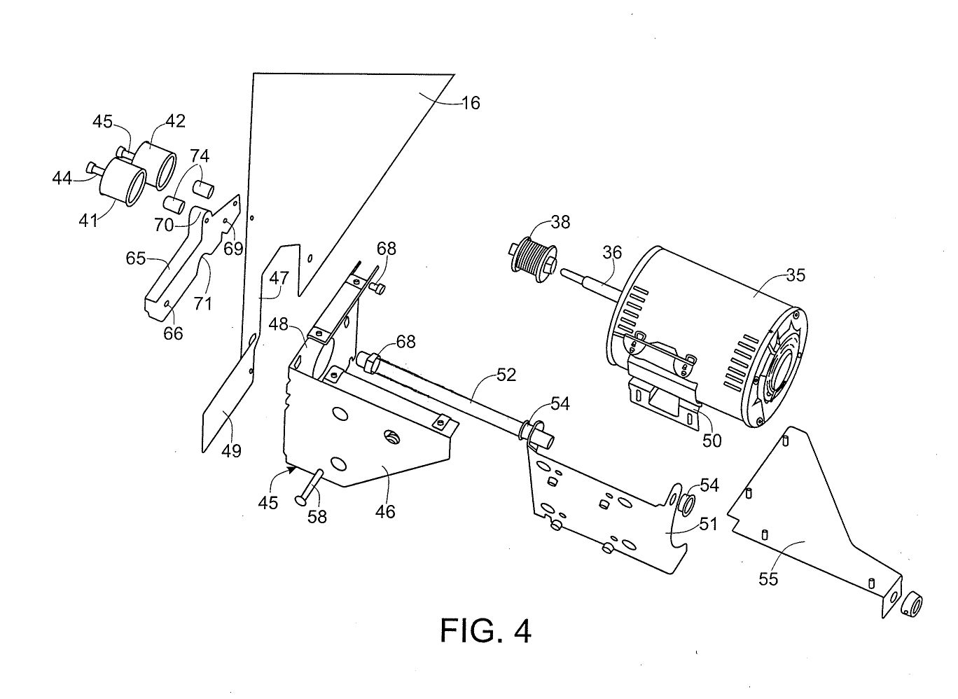

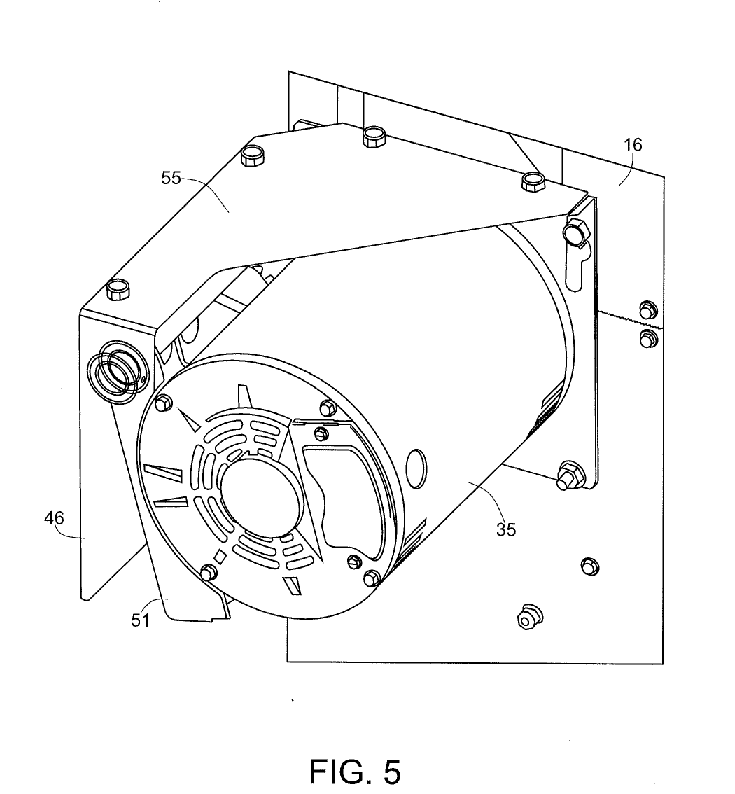

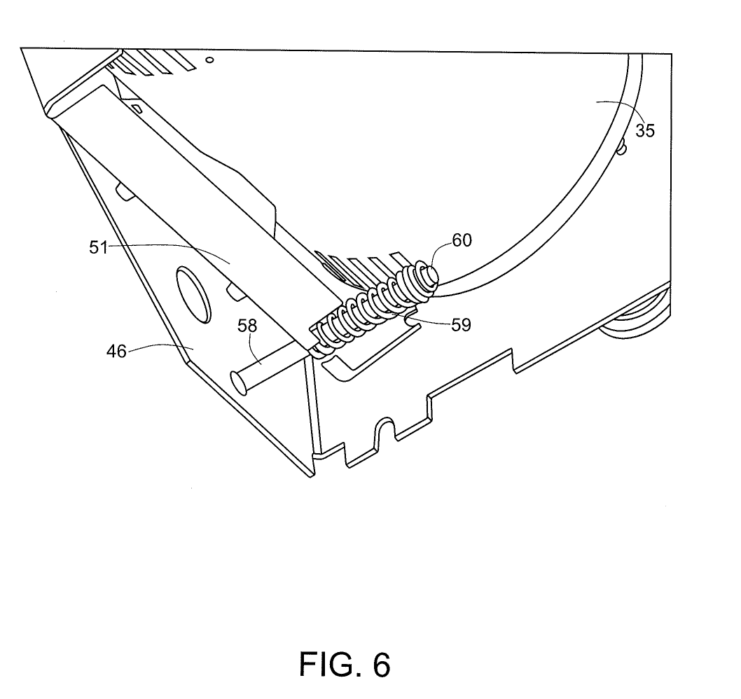

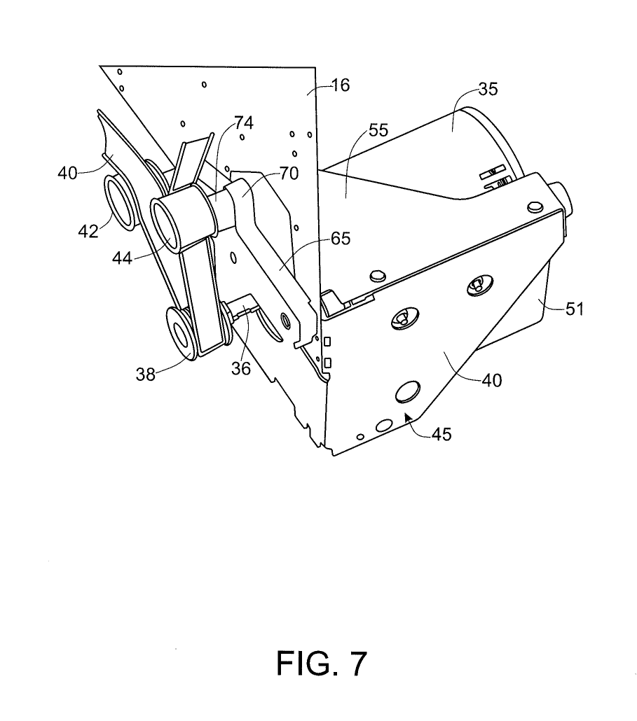

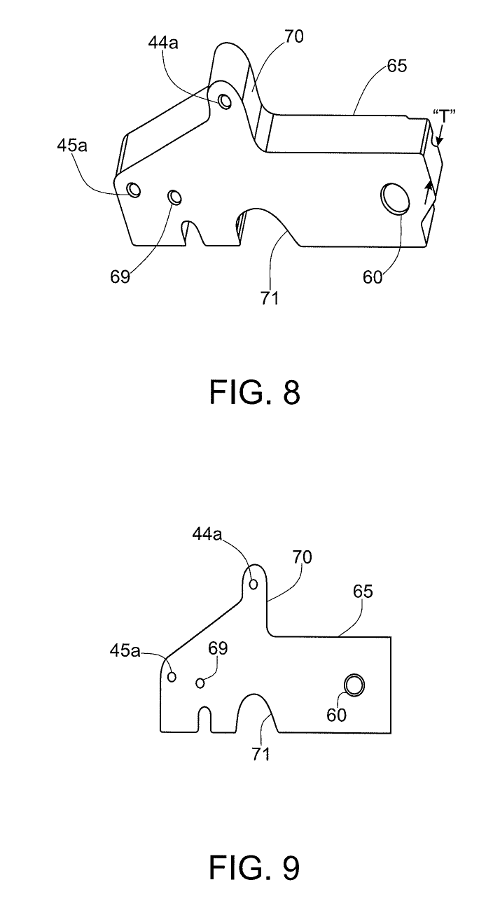

For rotatably driving the tumbler basket 18 during a drying operation, a drive motor 35 is mounted on a rear side of the cabinet panel 15 below the heater 25. The drive motor 35 has a drive shaft 36, which carries a drive pulley 38 disposed within the cabinet 11 for driving an endless belt 40 trained about the drive pulley 38 and the rear unperforated end 22 of the tumbler basket 18. The drive belt 40 preferably is of a poly-V construction having a driving side formed with a plurality of laterally spaced V-grooves for enhanced frictional engagement with corresponding grooves in the drive pulley 38. A pair of idler pulleys 41,42 each rotatably supported on a respective support shaft 44,45 (FIG. 4) are provided for guiding the belt 40 into tight frictional engagement about the outer periphery of the tumbler basket 18. The rear cabinet panel 16 in this case has a cutout opening 47 through which the motor shaft 36 extends and for permitting access to the drive pulley 38. A cover plate 49 is removably attached to the rear panel 16 closing an upper portion of the cutout opening during operation of the motor for minimizing air flow through the opening.

For facilitating drying of large items, such as sheets, lines, coats, and the like without tangling during rotation of the tumbler basket 18, the drive motor 35 is operable for sequentially reversing the direction of rotary movement of the tumbler basket 18. The drive motor 18 preferably is an 8-pole motor and is operable without slippage of the drive belt 40 on the drive pulley 38 for sequentially rotating the tumbler basket 11 up to 300 rpm every 30 seconds in opposite rotary direction. Heretofore, as indicated above, such sequential reversing of the drive motor can cause cracking or tearing of the rear panel of the cabinet upon which the drive motor is mounted, which typically is a thin sheet metal panel with a wall thickness of about only 0.033 inches in thickness. Reversing direction of the drive heretofore also can cause the drive belt 40 to become off-centered on drive and idler pulleys 38,41,42 resulting in edge wear and shortening of belt life, if not complete dislodgement of the belt from the pulleys.

In accordance with the invention, an improved mounting is provided for the drive motor and drive belt idler pulleys that prevents damage to the panel of the cabinet upon which the drive motor is mounted during rapid sequential reversal of direction of rotation of the tumbler basket and maintains the drive belt in substantially centered relation to the idler and drive pulleys. In the illustrated embodiment, the motor mounting includes a right angle bracket 45 comprising a first gusset plate 46 affixed to a rear side of the rear cabinet panel 15 transverse to the axis of the drive motor shaft 36 and a second integral right angle gusset plate 48 extending rearwardly from one side of the first gusset plate 46 parallel to the axis of the motor shaft 36. The drive motor 35 has a mounting bracket 50 affixed on a side that is bolted to a pivot plate 51 supported for pivotal movement on a support shaft 52 extending adjacent an upper side of the gusset plate 46 (FIG. 4). To facilitate pivotal movement of the pivot plate 51, bushings 54 are interposed between the support shaft 52 and mounting apertures of the pivot plate 51. A top cover plate 55, also having a tapered or gusseted configuration, is bolted to the top of the right-angled bracket 46 in overlying relation to the support rod 52.

For biasing the pivot plate 51 and the motor 35 mounted thereon such that the motor shaft 36 and drive pulley 38 are urged in a generally downward belt tightening direction, an elongated carriage bolt 58 and spiral spring 59 are provided. With a head of the carriage bolt 58 retained on an outer side of the gusset plate 46, the carriage bolt 58 extends through an aperture in the gusset and pivot plates 46,51, with the spiral spring 59 being biased between the pivot plate 51 and a nut 60 affixed to a terminal end of the carriage bolt 58. A biasing force of the spring 59 urges the pivot plate 51 in a downward direction toward the gusset plate 46, urging the drive motor 35 and drive pulley 38 in a downward direction for maintaining tension on the drive belt 40 during operation.

In carrying out the invention, the motor support shaft 52 and the idler pulley shafts 44 each is affixed to and supported by a stabilizing member 65, which is affixed to the rear cabinet panel 16 and dimensioned so as to be stronger and more robust than the relatively thin walled rear cabinet panel 16 for stabilizing the axes of the idler pulleys 41,42 and motor drive pulley 38 for more reliable operation. The illustrated stabilizing member 65 has an elongated configuration and is mounted on an inner side of the rear cabinet panel 16. The stabilizing member 65 has a threaded aperture 66 at one end for fixedly receiving and supporting a threaded end of the motor support rod 52 that extends through an aperture in the rear panel 16. A nut 68 carried by the support rod 52 is tightened against an outer side of the rear cabinet panel 16 for securely affixing the end of the stabilizing member 65 to the cabinet panel 16 (FIG. 4). A threaded fastener 68 engageable with a threaded aperture 69 of the stabilizing member 65 affixes the opposite end of the stabilizing member 65 to the cabinet panel 16. The shaft 45 of one idler pulley 42 in this case is threadably affixed to a threaded aperture 45a adjacent an end of the stabilizing member 65 opposite the end to which the motor support shaft 52 is affixed, and the shaft 44 of the other idler pulley 41 is threadedly supported in an aperture 45b in an upstanding integral hub 70 of the stabilizing member 65 in slightly elevated relation to the motor support rod 52 and the idler shaft 45. A tubular spacer 74 in this instance is interposed between each idler pulleys 42,44 and the stabilizing member 65. A downwardly opening cutout 71 is formed centrally within an underside of the stabilizing member 65 for providing clearance to the motor drive shaft 36 and pulley 38.

The illustrated stabilizing member 65, which may be made of cold rolled steel, has a transverse thickness “t” substantially greater than the thickness of the rear cabinet panel 16. Preferably, the stabilizing member has a thickness “t” of between 15 and 25 times the thickness of the rear cabinet panel 16, and most preferably at least 20 times the thickness of the rear cabinet panel 16. In the illustrated embodiment, the cabinet panel 16 has a thickness of 0.033 inches and the stabilizing member has a thickness of ⅝″. The stabilizing member 65 preferably has an elongated configuration with a long dimension of at least 8″.

While the theory of operation is not entirely understood, it is believed that the robust stabilizing member 65 maintains the axes of the drive and idler pulleys 38,41,42 in sufficiently parallel relation to each other sufficient to keep the drive belt 40 from straying away from the pulleys when operation of the drive motor is reversed. The stabilizing member 65 also solves the problem of attaching the reversing motor to the relatively thin sheet metal panel 16 of the dryer cabinet that is otherwise subject to fatigue and cracking caused by the shock forces and vibrations associated with reversal in the drive motor. The substantial thickness of the stabilizing member 65 is believed to spread the loads and absorb the shock forces and vibrations occurring by rapid stopping and starting of the motor in opposite direction.

From the foregoing, it can be seen that a laundry dryer is provided with a belt driven tumbler that is adapted for more reliable reversible operation. The drive belt is maintained in a stable centered position on the drive and idler pulleys during reversible operation, and the robust nature of the stabilizing member to which the motor support rod and idler pulleys are mounted or prevents fatigue cracking and tearing of the relatively thin rear cabinet panel upon which the motor is mounted.

1. A laundry dryer comprising:
a cabinet having a rear sheet metal panel,
a front opening tumbler basket mounted within said cabinet for rotation about a horizontal axis,
a drive motor mounted on said rear cabinet panel having a drive shaft with a drive pulley,
a drive belt disposed about said drive pulley and said tumbler basket such that operation of said drive motor rotates said tumbler basket,
at least one idler pulley acting on said drive belt during operation of said drive motor,
said idler pulley being rotatably supported on a support shaft
said drive motor being operable for sequentially driving said tumbler basket in opposite rotary directions, said drive motor being supported by a support rod,
a metal stabilizing member affixed to said rear cabinet panel, said stabilizing member having a transverse thickness greater than the thickness of said rear cabinet sheet metal panel, and
said at least one idler pulley support shaft and said drive motor support rod being affixed to and supported by said stabilizing member such that the axes of the at least one idler pulley and drive shaft remain parallel to sufficient for enabling the drive belt to maintain substantially centered position on the drive pulley and at least one idler pulley during reversible operation of the drive motor and tumbler basket.

2. The laundry dryer of claim 1 including two idler pulleys each rotatably supported by a respective support shaft affixed to and supported by said stabilizing member.

3. The laundry dryer of claim 1 in which said stabilizing member has a transverse thickness of between 15 and 25 times the thickness of said rear sheet metal panel.

4. The laundry dryer of claim 1 in which said stabilizing member has a transverse thickness at least 20 times the thickness of said rear sheet metal panel.

5. The laundry dryer of claim 1 in which said stabilizing member has an elongated configuration, said motor support rod being affixed to and supported at one end of said stabilizing member, and said at least one idler pulley support shaft being affixed to and supported adjacent an opposite end of said stabilizing member.

6. The laundry dryer of claim 1 including two idler pulleys each having a respective idler pulley support shaft, said support shaft of one of said idler pulleys being affixed to and supported adjacent one end of said stabilizing member and the support shaft of the other idler pulley being affixed to and supported intermediate the ends of the stabilizing member.

7. The laundry dryer of claim 1 in which said drive motor is disposed on an outer side of said rear cabinet panel, and said stabilizing member is affixed to an inner side of said rear cabinet panel.

8. The laundry dryer of claim 1 in which said stabilizing member is affixed to said cabinet member by at least one fastener extending through said rear panel for engagement with a threaded aperture in said stabilizing member and a retention bolt on said motor support shaft for engagement with an outer side of the rear cabinet panel.

9. The laundry dryer of claim 1 in which said stabilizing member has an elongated configuration with a horizontal dimension that is greater than the vertical dimension.

10. The laundry dryer of claim 9 in which said elongated support member has a length of at least 8 inches.

11. The laundry dryer of claim 1 in which said cabinet panel has a thickness of about 0.033 inches and said stabilizing member has a thickness of about ⅝ inch.

12. The laundry dryer of claim 1 in which said drive belt is disposed about said drive pulley and a rear portion of said tumbler basket.

13. The laundry dryer of claim 1 in which said motor is mounted on the pivot plate, said pivot plate being mounted on said support rod for relative pivotal movement, and a biasing spring for urging said pivot plate and the drive motor mounted thereon in a direction in which said drive pulley tensions said drive belt.

14. A laundry dryer comprising:
a cabinet having a rear sheet metal panel,
a front opening tumbler basket mounted within said cabinet for rotation about a horizontal axis,
a drive motor mounted on said rear cabinet panel having a drive shaft with a drive pulley,
a drive belt disposed about said drive pulley and said tumbler basket such that operation of said drive motor rotates said tumbler basket,
a plurality of idler pulleys acting on said drive belt during operation of said drive motor,
said idler pulleys each being rotatably supported on a respective support shaft,
said drive motor being operable for sequentially driving said tumbler basket in opposite rotary directions,
said drive motor being pivotably supported by a support rod,
a biasing spring for urging said drive motor in a direction in which said drive pulley tensions said belt,
a metal stabilizing member affixed to said rear cabinet panel, said stabilizing member having a transverse thickness greater than the thickness of said rear cabinet sheet metal panel, and
said idler pulley support shafts and said drive motor support rod each being affixed to and supported by said stabilizing member such that the axes of the idler pulleys and said drive shaft remain parallel to sufficient for enabling the drive belt to maintain substantially centered position on the drive and idler pulleys during reversible operation of the drive motor and tumbler basket.

15. The laundry dryer of claim 14 in which said stabilizing member has a transverse thickness of between 15 and 25 times the thickness of said rear sheet metal panel.

16. The laundry dryer of claim 14 in which said stabilizing member has a transverse thickness at least 20 times the thickness of said rear sheet metal panel.

17. The laundry dryer of claim 14 in which said stabilizing member has an elongated configuration, said motor support rod being affixed to and supported at one end of said stabilizing member, said support shaft of one of said idler pulleys being affixed to and supported adjacent one end of said stabilizing member, and the support shaft of the other idler pulley being affixed to and supported intermediate the ends of the stabilizing member.

18. The laundry dryer of claim 14 in which said drive motor is disposed on an outer side of said rear cabinet panel, and said stabilizing member is affixed to an inner side of said rear cabinet panel.

19. The laundry dryer of claim 14 in which said stabilizing member has an elongated configuration with a horizontal dimension that is greater than the vertical dimension.

20. The laundry dryer of claim 19 in which said elongated support member has a length of at least 8 inches.
